(19) United States
(12) Patent Application Publication
(10) Pub. No.: US 2025/0374984 A1
(43) Pub. Date: Dec. 11, 2025

(54) CONNECTOR

(71) Applicant: MIPS AB, Täby (SE)

(72) Inventor: Amy Louise Pomering, Täby (SE)

(21) Appl. No.: 19/124,263

(22) PCT Filed: Oct. 25, 2023
(86) PCT No.: PCT/EP2023/079790

§ 371 Date: Apr. 24, 2025

(30) Foreign Application Priority Data
Oct. 26, 2022 (GB) 2215848.9

(51) Int. Cl. A42B 3/04; A42B 3/06

(52) U.S. Cl. CPC A42B 3/0406; A42B 3/06

(57) ABSTRACT

A connector (5, 20) for connecting first (4) and second (3) parts of an apparatus (1, 100), the connector comprising: a first attachment part (21, 210) configured to be attached to the first part of the apparatus; a second attachment part (22, 220) configured to be attached to the second part of the apparatus, the second attachment part comprising a first part of a connecting means (22) configured to be detachably attached to a second part of the connecting means (40) provided to the second part of the apparatus; a low friction layer (23) arranged adjacent to the first part of the connecting means in a lateral direction substantially perpendicular to a direction of connection between the first and second parts of the apparatus; wherein, when the first part of the connecting means is attached to the second part of the connecting means, the first part of the connecting means is configured detach from the second part of the connecting means as the connector is displaced in a lateral direction relative to the second part of the connecting means such that the low friction layer moves towards the second part of the connecting means, and the low friction layer is configured to slide against the second part of the connecting means as the first part of the connecting means detaches therefrom.

### TECHNICAL FIELD

The present disclosure relates to a connector for connecting first and second parts of an apparatus and an apparatus, which may be a protective apparatus such as a helmet, comprising the connector.

### BACKGROUND ART

Impact protection apparatuses generally aim to reduce the energy transferred to an object, such as a person to be protected, by an impact. This may be achieved by energy absorbing means, energy redirecting means, or a combination thereof. Energy absorbing means may include energy absorbing materials, such as a foam materials, or structures configured to deform elastically and/or plastically in response to an impact. Energy redirecting means may include structures configured to slide, shear or otherwise move in response to an impact.

Impact protection apparatuses include protective apparel for protecting a wearer of the apparel. Protective apparel comprising energy absorbing means and/or energy redirecting means is known. For example, such means are implemented extensively in protective headgear, such as helmets.

Examples of helmets comprising energy absorbing means and energy redirecting means include WO 2001/045526 and WO 2011/139224 (the entirety of which are herein incorporated by reference). Specifically, these helmets include at least one layer formed from an energy absorbing material and at least one layer that can move relative to the head of the wearer of the helmet under an impact.

Implementing moving parts in a protective apparatus has challenges. For example, connecting two layers of an apparatus in such a way that permits enough relative movement between parts of the apparatus under an impact but maintains the structural integrity of the apparatus can be challenging. Ensuring that the connector can be manufactured and assembled relatively easily can be challenging.

Further, ensuring desired relative movement between moving parts under an impact can be challenging. Ensuring that the apparatus can be manufactured and assembled relatively easily can be challenging.

It is the aim of the present invention to provide a connector and an apparatus comprising the connector that at least partially address some of the problems discussed above.

### SUMMARY OF THE INVENTION

According to an aspect of the disclosure, there is provided a connector for connecting first and second parts of an apparatus, the connector comprising: a first attachment part configured to be attached to the first part of the apparatus; a second attachment part configured to be attached to the second part of the apparatus, the second attachment part comprising a first part of a connecting means configured to be detachably attached to a second part of the connecting means provided to the second part of the apparatus; a low friction layer arranged adjacent to the first part of the connecting means in a lateral direction substantially perpendicular to a direction of connection between the first and second parts of the apparatus; wherein, when the first part of the connecting means is attached to the second part of the connecting means, the first part of the connecting means is configured to detach from the second part of the connecting means as the connector is displaced in a lateral direction relative to the second part of the connecting means such that the low friction layer moves towards the second part of the connecting means, and the low friction layer is configured to slide against the second connecting means as the first part of the connecting means detaches therefrom.

Optionally, the connector is substantially smaller in the lateral direction than the first and second parts of the apparatus.

Optionally, the low friction layer substantially surrounds the first part of the connecting means in the lateral direction. Optionally, the low friction layer comprises an aperture surrounding the first part of the connecting means in the lateral direction. Optionally, the low friction layer covers substantially all of a surface of the connector, except the aperture.

Optionally, the low friction layer is configured to facilitate detachment of the first part of the connecting means from the second part of the connecting means.

Optionally, at least a portion of an edge of the low friction layer facing the first part of the connecting means in the lateral direction is ridged, toothed or serrated.

Optionally, the low friction layer is no more than 1 mm thick.

Optionally, the low friction layer is substantially stiff.

Optionally, the low friction layer is formed from plastic.

Optionally, the connecting means is a hook and loop connecting means, wherein one of the first part of the connecting means and the second part of the connecting means is a hook part, and the other of the of the first part of the connecting means and the second part of the connecting means is a loop part. Optionally, the connector comprises a layer of hook or loop material, partially covered by the low friction layer such that a portion of the layer of hook or loop material is exposed, said exposed portion providing the second attachment part. Optionally, the first attachment part is provided on the opposite side of the layer of hook or loop material to the low friction layer.

Optionally, the first attachment part comprises a first part of a hook and loop connection means.

Optionally, the first attachment part comprises an adhesive connection means.

Optionally, the connector is substantially flat in the direction of connection between the first and second part of the apparatus.

Optionally, the connector has a substantially circular, rectangular or rounded-rectangular shape.

Optionally, the connector has a maximum dimension in the lateral direction that does not exceed 50 mm.

According to a second aspect of the disclosure there is provided an apparatus comprising: a first part; a second part; and at least one connector according to any preceding aspect connecting the first and second part of the apparatus; at least one respective second part of the connecting means, attached to the second part of the apparatus.

Optionally, the first and second parts of the apparatus are configured to move relative to each other in the lateral direction. Optionally, the apparatus further comprises a low friction interface between the first and second parts of the apparatus.

Optionally, at least one of the first part and the second part of the apparatus comprises a protective layer, optionally an energy absorbing layer or a hard shell, configured to protect against an impact to the apparatus. Optionally, one of the first and second parts comprises an interface layer configured to interface with an object or person to be protected.

Optionally, the apparatus is a helmet. Optionally, the apparatus is body armour.

### BRIEF DESCRIPTION OF THE DRAWINGS

The invention is described in detail below, with reference to the accompanying figures, in which:

FIG. 1 schematically shows a cross-section through a first example helmet;

FIG. 2 schematically shows a cross-section through a second example helmet;

FIG. 3 schematically shows a cross-section through a third example helmet;

FIG. 4 schematically shows a cross-section through a fourth example helmet;

FIG. 5 schematically shows a cross-section through a fifth example helmet;

FIG. 6 schematically shows a cross-section through a sixth example helmet;

FIG. 7 schematically shows a cross-section through a seventh example helmet;

FIG. 8 shows an eighth example helmet;

FIG. 9 shows a first example of body armour;

FIG. 10 shows a second example of body armour;

FIG. 11 schematically shows a cross-section through a ninth example helmet;

FIG. 12 shows a first example connector;

FIG. 13 shows a second example connector;

FIG. 14 shows a third example connector;

FIG. 15 shows a fourth example connector;

FIGS. 16A and 16B show an example connector in situ in an example helmet;

FIG. 17 shows example components forming a layered structure;

FIG. 18 shows example components forming an example connector;

FIG. 19 shows example components forming an example connector;

FIG. 20 shows example components forming an example connector; and

FIG. 21 shows bonded regions of example connectors;

FIG. 22 shows an example interface layer comprising a plurality of connectors.

### DETAILED DESCRIPTION

It should be noted that the Figures are schematic, the proportions of the thicknesses of the various layers, and/or of any gaps between layers, depicted in the Figures have been exaggerated for the sake of clarity and can of course be adapted according to need and requirements.

Although the examples described below relate to helmets, it should be understood that the invention applies generally to protective apparatuses, including other types of headgear and other protective apparel.

Protective apparatuses can be understood to have parts corresponding to the parts of the helmets described below. For example, protective apparatuses may have a layered structure corresponding to the layered structure of the described helmets.

Terms that are specific to a helmet, such as “radial direction” can be understood to have equivalents in the context of other protective equipment, such as “thickness direction”. A “wearer” is to generally understood as corresponding to an object that is to be protected by the protective apparatus, and “head” as a specific part of the object, e.g. a different body part, with which the apparatus is in contact.

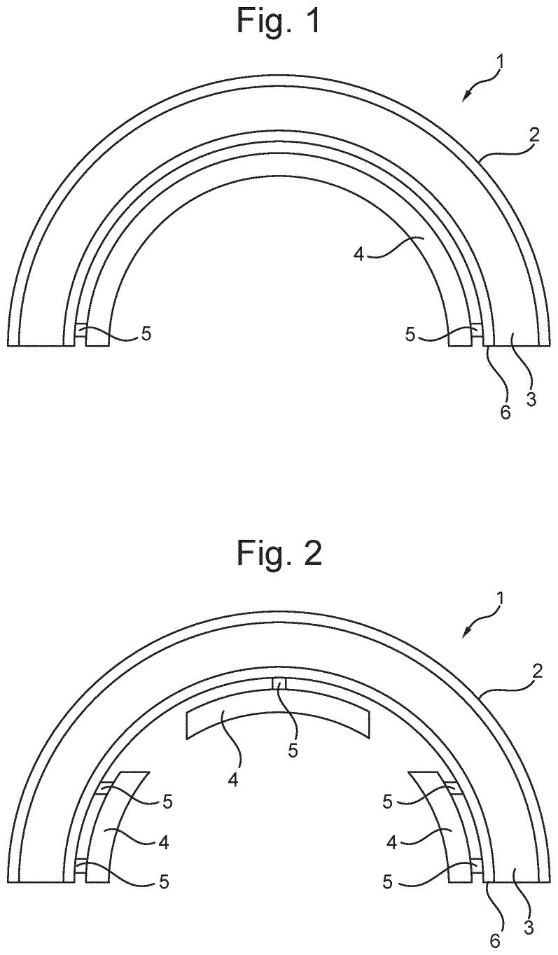

General features of the example helmets are described below with reference to FIGS. 1 to 7.

FIGS. 1 to 7 show example helmets 1 comprising an energy absorbing layer 3. The purpose of the energy absorbing layer 3 is to absorb and dissipate energy from an impact in order to reduce the energy transmitted to the wearer of the helmet 1. Within the helmet 1, the energy absorbing layer 3 may be the primary energy absorbing element. Although other elements of the helmet 1 may absorb that energy to a more limited extent, this is not their primary purpose.

The energy absorbing layer 3 may absorb energy from a radial component of an impact more efficiently than a tangential component of an impact. The term “radial” generally refers to a direction substantially toward the centre of the wearers head, e.g. substantially perpendicular to an outer surface of the helmet 1. The term “tangential” may refer to a direction substantially perpendicular to the radial direction, in a plane comprising the radial direction and the impact direction.

The energy absorbing layer 3 may be formed from an energy absorbing material, such as a foam material. Preferable such materials include expanded polystyrene (EPS), expanded polypropylene (EPP), expanded polyurethane (EPU), vinyl nitrile foam; or strain rate sensitive foams such as those marketed under the brand-names Poron™ and D3O™.

Alternatively, or additionally, the energy absorbing layer 3 may have a structure that provides energy absorbing characteristics. For example, the energy absorbing layer 3 may comprise deformable elements, such as cells or finger-like projections, that deform upon impact to absorb and dissipate the energy of an impact.

As illustrated in FIG. 6, the energy absorbing layer 3 of the helmet 1 is may be divided into outer and inner parts 3A, 3B.

As illustrated in FIG. 11, the energy absorbing layer 3 may be divided into multiple parts arranged adjacent each other in the circumferential direction of the helmet. FIG. 11 shows such a helmet of the type shown in FIG. 6, with the inner parts 3B being formed in front and back parts 3C and 3D.

The energy absorbing layer 3 is not limited to one specific arrangement or material. The energy absorbing layer 3 may be provided by multiple layers having different arrangements, i.e. formed from different materials or having different structures. The energy absorbing layer 3 may be a relatively thick layer. For example, it may be the thickest layer of the helmet 1.

FIGS. 1 to 7 show example helmets 1 comprising an outer layer 2. The purpose of the outer layer 2 may be to provide rigidity to the helmet 1. This may help spread the impact energy over a larger area of the helmet 1. The outer layer 2 may also provide protection against objects that might pierce the helmet 1. Accordingly, the outer shell 2 may be a relatively strong and/or rigid layer, e.g. compared to an energy absorbing layer 3. The outer layer 2 may be a relatively thin layer, e.g. compared to an energy absorbing layer 3.

The outer layer 2 may be formed from a relatively strong and/or rigid material. Preferable such materials include a polymer material such as polycarbonate (PC), polyvinylchloride (PVC) or acrylonitrile butadiene styrene (ABS) for example. Advantageously, the polymer material may be fibre-reinforced, using materials such as glass-fibre, Aramid, Twaron, carbon-fibre and/or Kevlar.

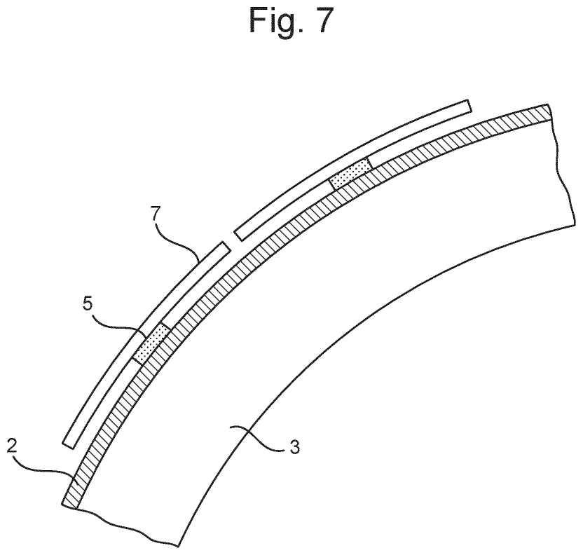

As shown in FIG. 7, one or more outer plates 7 may be mounted to the outer layer 2 of the helmet 1. The outer plates 7 may be formed from a relatively strong and/or rigid material, for example from the same types of materials as from which the outer layer 2 may be formed. The selection of material used to form the outer plates 7 may be the same as, or different from, the material used to form the outer layer 2.

In some example helmets, the outer layer 2 and/or the energy absorbing layer 3 may be adjustable in size in order to provide a customised fit. For example the outer layer 2 may be provided in separate front and back parts. The relative position of the front and back parts may be adjusted to change the size of the outer layer 2. In order to avoid gaps in the outer layer 2, the front and back parts may overlap. The energy absorbing layer 3 may also be provided in separate front and back parts (e.g. as shown in FIG. 11). These may be arranged such that the relative position of the front and back parts may be adjusted to change the size of the energy absorbing layer 3. In order to avoid gaps in the energy absorbing layer 3, the front and back parts may overlap.

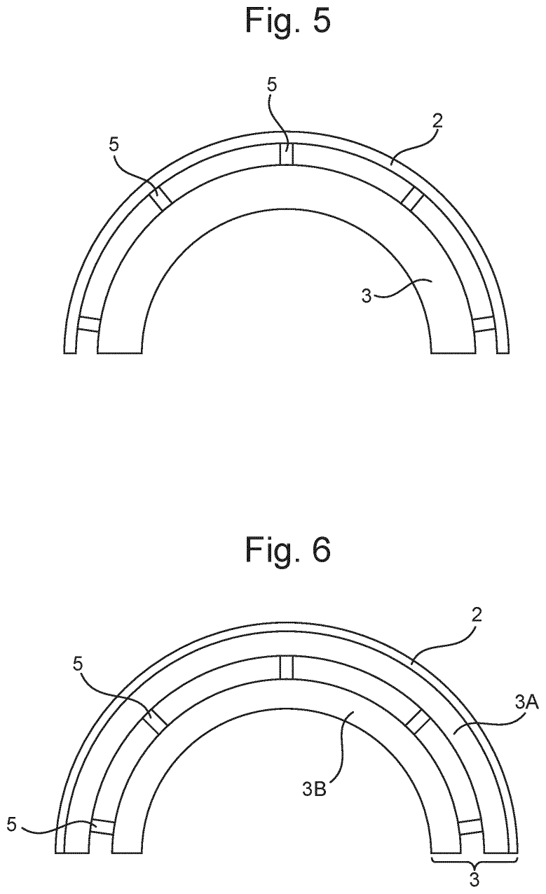

FIGS. 1 to 4 show example helmets 1 comprising an interface layer 4. Although not shown in FIGS. 5 to 7, these example helmets may also comprise an interface layer 4. The purpose of the interface layer 4 may be to provide an interface between the helmet 1 and the wearer. In some arrangements, this may improve the comfort of the wearer. The interface layer 4 may be provided to mount the helmet 1 on the head of a wearer. The interface layer 4 may be provided as a single part or in multiple sections.

The interface layer 4 may be configured to at least partially conform to the head of the wearer. For example, the interface layer 4 may be elasticated and/or may comprise an adjustment mechanism for adjusting the size of the interface layer 4. In an arrangement, the interface layer 4 may engage with the top of a wearer's head. Alternatively, or additionally, the interface layer 4 may comprise an adjustable band configured to encircle the wearer's head.

The interface layer 4 may comprise comfort padding 4A. Multiple sections of comfort padding 4A may be provided. The comfort padding 4A may be provided on a substrate 4B for mounting the comfort padding to the rest of the helmet 1.

The purpose of the comfort padding 4A is to improve comfort of wearing the helmet and/or to provide a better fit. The comfort padding 4A may be formed from a relatively soft material, e.g. compared to the energy absorbing layer 3 and/or the outer layer 2. The comfort padding 4A may be formed from a foam material. However, the foam material may be of lower density and/or thinner than foam materials used for the energy absorbing layer 3. Accordingly, the comfort padding 4A will not absorb a meaningful amount of energy during an impact, i.e. for the purposes of reducing the harm to the wearer of the helmet. Comfort padding is well recognised in the art as being distinct from energy absorbing layers, even if they may be constructed from somewhat similar materials.

The interface layer 4, and/or comfort padding 4A that may be part of it, may be removable. This may enable the interface layer 4 and/or comfort passing 4A to be cleaned and/or may enable the provision of an interface layer and/or comfort padding 4A that is configured to fit a specific wearer.

Straps, e.g. chin straps, may be provided to secure the helmet 1 to the head of the wearer.

The helmets of FIGS. 1 to 4 are configured such that the interface layer 4 is able to move, for example slide, in a tangential direction relative to the energy absorbing layer 3 in response to an impact. As shown in FIGS. 1 to 4, the helmet 1 may also comprise connectors 5 between the energy absorbing layer 3 and the interface layer 4 that allow relative movement between the energy absorbing layer 3 and the interface layer 4 while connecting the elements of the helmet 1 together.

The helmet 1 of FIG. 5 is configured such that the outer layer 2 is able to move, for example slide, in a tangential direction relative to the energy absorbing layer 3 in response to an impact. As shown in FIG. 5, the helmet 1 may also comprise connectors 5 between the energy absorbing layer 3 and the outer layer 2 that allow relative movement between the energy absorbing layer 3 and the outer layer 2 while connecting the elements of the helmet 1 together.

The helmet 1 of FIG. 6 is configured such that the outer part 3A of the energy absorbing layer 3 is able to move, for example slide, in a tangential direction relative to the inner part 3B of the energy absorbing layer 3 in response to an impact. As shown in FIG. 6, the helmet 1 may also comprise connectors 5 between the outer part 3A of the energy absorbing layer 3 and the inner part 3B of the energy absorbing layer 3, that allow relative movement between the outer part 3A of the energy absorbing layer 3 and the inner part 3B of the energy absorbing layer 3, while connecting the elements of the helmet 1 together.

In examples, such as that of FIG. 11, in which an energy absorbing layer 3 is split into multiple parts 3C and 3D arranged adjacent each other in the circumferential direction of the helmet, these parts may be configured to move relative to each other, as well as other parts of the helmet 1.

The helmet of FIG. 7 is configured such that the outer plates 8 are able to move, for example slide, in a tangential direction relative to the outer layer 2 in response to an impact. As shown in FIG. 7, the helmet may also comprise connectors 5 between the outer plates 8 and the outer layer 2 that allow relative movement between the outer plates 7 and the outer layer 2, while connecting the elements of the helmet 1 together.

The purpose of helmet layers that move or slide relative to each other may be to redirect energy of an impact that would otherwise be transferred to the head the wearer. This may improve the protection afforded to the wearer against a tangential component of the impact energy. A tangential component of the impact energy would normally result in rotational acceleration of the head of the wearer. It is well know that such rotation can cause brain injury. It has been shown that helmets with layers that move relative to each other can reduce the rotational acceleration of the head of the wearer. A typical reduction may be roughly 25% but reductions as high as 90% may be possible in some instances.

Preferably, relative movement between helmet layers results in a total shift amount of at least 0.5 cm between an outermost helmet layer and an inner most helmet layer, more preferably at least 1 cm, more preferably still at least 1.5 cm. Preferably the relative movement can occur in any direction, e.g. in a circumferential direction around the helmet, left to right, front to back and any direction in between.

Relative movement can be considered to occur substantially in a plane over the relevant ranges, at a specific location, such as at a connector 5, even though movement between layers may be rotational rather than linear. Accordingly, reference may be made below to movement in a plane.

Regardless of how helmet layers are configured to move relative to each other, it is preferable that the relative movement, such as sliding, is able to occur under forces typical of an impact for which the helmet 1 is designed (for example an impact that is expected to be survivable for the wearer). Such forces are significantly higher than forces that a helmet may be subject to during normal use. Impact forces tend to compress layers of the helmet 1 together, increasing the reaction force between components and thus increasing frictional forces. Where helmets are configured to have layers sliding relative to each other the interface between them may need to be configured to enable sliding even under the effect of the high reaction forces experienced between them under an impact.

As shown in FIGS. 1 to 7, a sliding interface may be provided between the layers of the helmet 1 that are configured to move relative to each other. At the sliding interface, surfaces slide against each other to enable relative sliding between the layers of the helmet 1. The sliding interface may be a low friction interface. Accordingly, friction reducing means may be provided at the sliding interface. Example sliding interfaces are described further below, in relation to each of the example helmets 1 shown in FIGS. 1 to 7.

The friction reducing means may be a low friction material or lubricating material. These may be provided as a continuous layer, or multiple discrete patches, or portions of material, for example. Possible low friction materials for the friction reducing means include waxy polymers such as PC, PTFE, ABS, PVC, Nylon, PFA, FEP, PE and UHMWPE, Teflon™, a woven fabric such as Tamarack™, a non-woven fabric, such a felt. Such low friction materials may have a thickness of roughly 0.1-5 mm, but other thicknesses can also be used, depending on the material selected and the performance desired. Possible lubricating materials include oils, polymers, microspheres, or powders. Combinations of the above may be used.

In one example, the low friction material or lubricating material may be a polysiloxane-containing material. In particular, the material may comprise (i) an organic polymer, a polysiloxane and a surfactant; (i) an organic polymer and a copolymer based on a polysiloxane and an organic polymer; or (iii) a non-elastomeric cross-linked polymer obtained or obtainable by subjecting a polysiloxane and an organic polymer to a cross-linking reaction. Preferred options for such materials are described in WO 2017/148958 (the entirety of which are herein incorporated by reference).

In one example, the low friction material or lubricating material may comprise a mixture of (i) an olefin polymer, (ii) a lubricant, and optionally one or more further agents. Preferred options for such materials are described in WO 2020/115063 (the entirety of which are herein incorporated by reference).

In one example, the low friction material or lubricating material may comprise an ultra high molecular weight (UHMW) polymer having a density of ≤960 kg/m³, which UHMW polymer is preferably an olefin polymer. Preferred options for such materials are described in WO 2020/115063.

In one example, the low friction material or lubricating material may comprise a polyketone. Preferred options for such materials are described in WO 2020/260185 (the entirety of which are herein incorporated by reference).

In some arrangements, it may be desirable to configure the low friction interface such that the static and/or dynamic coefficient of friction between materials forming sliding surfaces at the sliding interface is between 0.001 and 0.3 and/or below 0.15. The coefficient of friction can be tested by standard means, such as standard test method ASTM D1894.

The friction reducing means may be provided on or be an integral part of one or both of the layers of the helmet 1 that are configured to slide relative to each other. In some examples, helmet layers may have a dual function, including functioning as a friction reducing means. Alternatively, or additionally, the friction reducing means may be a separate from the layers of the helmet 1 that are configured to slide relative to each other, but provided between the layers.

Instead of the sliding interface, in some examples, a shearing interface may be provided between the layers of the helmet 1 that are configured to move relative to each other. At the shearing interface, a shearing layer shears to enable relative movement between the layers of the helmet 1. The shearing layer may comprise a gel or liquid, which may be retained within a flexible envelope. Alternatively, the shearing layer may comprise two opposing layers connected by deformable elements that deform to enable shearing between the two opposing layers.

A single shearing layer may be provided that substantially fills the volume between two layers of a helmet. Alternatively, one or more shearing layers may be provided that fill only a portion of the volume between two layers of a helmet, e.g. leaving substantial space around the shearing layers. The space may comprise a sliding interface, as described above. As such, helmets may have a combination of shearing and sliding interfaces. Such shearing layers may act as connectors 5, which are described further below.

FIGS. 1 to 7 schematically show connectors 5. The connectors 5 are configured to connect two layers of the helmet while enabling relative movement, e.g. sliding or shearing, between the layers. Different numbers of connectors 5 may be provided than as shown in FIGS. 1 to 7. The connectors 5 may be located at different positions than as shown in FIGS. 1 to 7, for example at a peripheral edge of the helmet 1 instead of a central portion.

Typically, a connector 5 comprises first and second attachment parts respectively configured to attach to first and second parts of the helmet and a deformable part between the first and second attachment parts that enables the first and second attachment parts to move relative to each other to enable movement between the first and second parts of the helmet of the helmet. Connectors 5 may absorb some impact energy by deforming. However, connectors need not have this specific configuration.

The specific arrangements of each of the example helmets shown in FIGS. 1 to 7 are described below.

FIG. 1 shows a helmet 1 comprising an outer layer 2, an energy absorbing layer 3 and an interface layer 4. The interface layer 4 is provided as a single layer and comprises comfort padding.

The helmet 1 of FIG. 1 is configured such that the interface layer 4 is able to slide relative to the energy absorbing layer 3 in response to an impact. A sliding interface is provided between the interface layer 4 and the energy absorbing layer 3.

A sliding layer 7 is provided on a surface of the energy absorbing layer 3 facing the sliding interface. The sliding layer 7 may be moulded to the energy absorbing layer 3 or otherwise attached thereto. The sliding layer 7 may be formed from a relatively hard material, e.g. relative to the energy absorbing layer 3. The sliding layer 7 is configured to provide friction reducing means to reduce the friction at the sliding interface. This may be achieved by forming the sliding layer 7 from a low friction material, such as PC, PTFE, ABS, PVC, Nylon, PFA, FEP, PE and UHMWPE. Alternatively, or additionally, this may be achieved by applying a low friction coating to the sliding layer 7, and/or applying a lubricant to the sliding layer 7.

Alternatively or additionally, friction reducing means, to reduce the friction at the sliding interface, may be provided by forming the energy absorbing layer 3 from a low friction material, by applying a low friction coating to the energy absorbing layer 3 and/or applying a lubricant to the energy absorbing layer 3.

The helmet 1 shown in FIG. 1 also comprises connectors 5 attached to the interface layer 4. The connectors are also connected to the sliding layer 7 to allow relative sliding between the energy absorbing layer 3 and the interface layer 4. Alternatively, or additionally, one or more of the connectors 5 may be connected to another part of the remainder of the helmet 1, such as the energy absorbing layer 3 or the outer shell 2. The connectors 5 may also be connected to two or more parts of the remainder of the helmet 1.

It should be understood that such an arrangement of the energy absorbing layer 3 and the interface layer 4 may be added to any helmet described herein.

FIG. 2 shows a helmet comprising an outer layer 2, an energy absorbing layer 3 and an interface layer 4. The interface layer 4 is provided as a plurality of independent sections each comprising comfort padding.

The helmet of FIG. 2 is configured such that the section of the interface layer 4 are able to slide relative to the energy absorbing layer 3 in response to an impact. A sliding interface is provided between the sections of the interface layer 4 and the energy absorbing layer 3.

An sliding layer 7 is provided on a surface of the energy absorbing layer 3 facing the sliding interface. The sliding layer 7 may be moulded to the energy absorbing layer 3 or otherwise attached thereto. The sliding layer 7 may be formed from a relatively hard material, e.g. relative to the energy absorbing layer 3. The sliding layer 7 is configured to provide friction reducing means to reduce the friction at the sliding interface. This may be achieved by forming the sliding layer 7 from a low friction material, such as PC, PTFE, ABS, PVC, Nylon, PFA, FEP, PE and UHMWPE. Alternatively, or additionally, this may be achieved by applying a low friction coating to the sliding layer 7, and/or applying a lubricant to the sliding layer 7.

Alternatively or additionally, friction reducing means, to reduce the friction at the sliding interface, may be provided by forming the energy absorbing layer 3 from a low friction material, by applying a low friction coating to the energy absorbing layer 3 and/or applying a lubricant to the energy absorbing layer 3.

The helmet 1 shown in FIG. 2 also comprises connectors 5 attached to each independent section of the interface layer 4. The connectors 5 are also attached to the sliding layer 7 to allow relative sliding between the energy absorbing layer 3 and the sections of the interface layer 4. Alternatively or additionally, one or more of the connectors 5 may be connected to another part of the remainder of the helmet 1, such as the energy absorbing layer 3 or the outer shell 2. The connectors 5 may also be connected to two or more parts of the remainder of the helmet 1.

It should be understood that such an arrangement of the energy absorbing layer 3 and the interface layer 4 may be added to any helmet described herein.

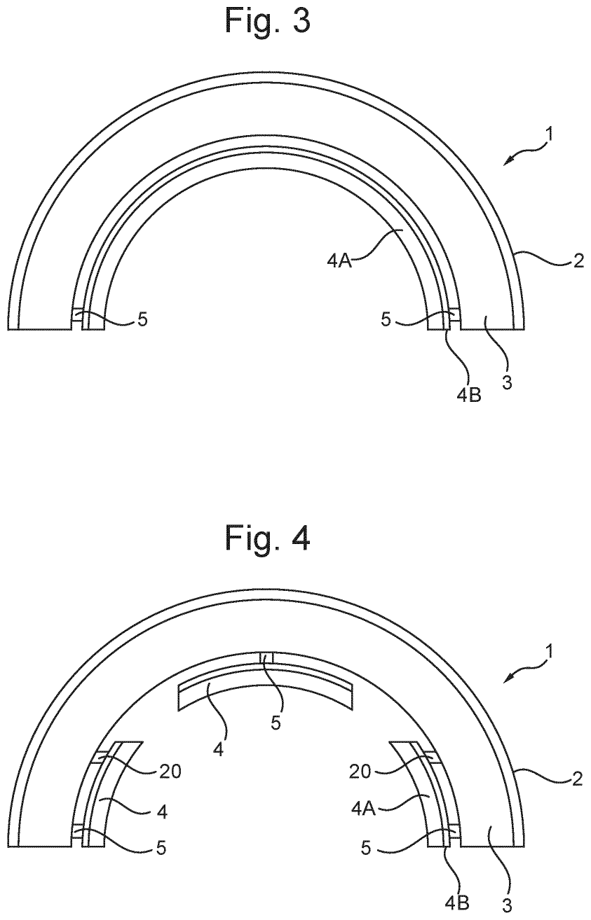

FIG. 3 shows a helmet 1 comprising an outer layer 2, an energy absorbing layer 3 and an interface layer 4. The interface layer 4 is provided as a single layer and comprises comfort padding 4A attached to a substrate 4B. The substrate 4B may be bonded to the outer side of the comfort padding 4A. Such bonding could be through any means, such as by adhesive or by high frequency welding or stitching.

The helmet of FIG. 3 is configured such that the interface layer 4 is able to slide relative to the energy absorbing layer 3 in response to an impact. A sliding interface is provided between the interface layer 4 and the energy absorbing layer 3.

The substrate 4B of the interface layer 4 faces the sliding interface. The substrate 4B may be formed from a relatively hard material, e.g. relative to the energy absorbing layer 3 and/or the comfort padding 4A. The substrate 4B is configured to provide friction reducing means to reduce the friction at the sliding interface. This may be achieved by forming the substrate 4B from a low friction material, such as PC, PTFE, ABS, PVC, Nylon, PFA, FEP, PE and UHMWPE. Alternatively, or additionally, this may be achieved by applying a low friction coating to the substrate 4B, and/or applying a lubricant to the substrate 4B. In alternative example, the substrate 4B may be formed from a fabric material, optionally coated with a low friction material.

Alternatively or additionally, friction reducing means, to reduce the friction at the sliding interface, may be provided by forming the energy absorbing layer 3 from a low friction material, by applying a low friction coating to the energy absorbing layer 3 and/or applying a lubricant to the energy absorbing layer 3.

The helmet 1 shown in FIG. 3 also comprises connectors 5 attached to the interface layer 4. The connectors are also connected to the energy absorbing layer to allow relative sliding between the energy absorbing layer 3 and the interface layer 4. Alternatively, or additionally, one or more of the connectors 5 may be connected to another part of the remainder of the helmet 1, such as the outer shell 2. The connectors 5 may also be connected to two or more parts of the remainder of the helmet 1

It should be understood that such an arrangement of the energy absorbing layer 3 and the interface layer 4 may be added to any helmet described herein.

FIG. 4 shows a helmet 1 comprising an outer layer 2, an energy absorbing layer 3 and an interface layer 4. The interface layer 4 is provided as a plurality of independent sections each comprising comfort padding 4A attached to a substrate 4B. The substrate 4B may be bonded to the outer side of the comfort padding 4A. Such bonding could be through any means, such as by adhesive or by high frequency welding or stitching.

The helmet 1 of FIG. 4 is configured such that the interface layer 4 is able to slide relative to the energy absorbing layer 3 in response to an impact. A sliding interface is provided between the interface layer 4 and the energy absorbing layer 3.

The substrate 4B of the sections of the interface layer 4 faces the sliding interface. The substrate 4B may be formed from a relatively hard material, e.g. relative to the energy absorbing layer 3 and/or the comfort padding 4A. The substrate 4B is configured to provide friction reducing means to reduce the friction at the sliding interface. This may be achieved by forming the substrate 4B from a low friction material, such as PC, PTFE, ABS, PVC, Nylon, PFA, FEP, PE and UHMWPE. Alternatively, or additionally, this may be achieved by applying a low friction coating to the substrate 4B, and/or applying a lubricant to the substrate 4B. In alternative example, the substrate 4B may be formed from a fabric material, optionally coated with a low friction material.

Alternatively or additionally, friction reducing means, to reduce the friction at the sliding interface, may be provided by forming the energy absorbing layer 3 from a low friction material, by applying a low friction coating to the energy absorbing layer 3 and/or applying a lubricant to the energy absorbing layer 3.

The helmet 1 shown in FIG. 4 also comprises connectors 5 attached to the sections of the interface layer 4. The connectors 5 are also connected to the energy absorbing layer 3 to allow relative sliding between the energy absorbing layer 3 and the interface layer 4. Alternatively, or additionally, one or more of the connectors 5 may be connected to another part of the remainder of the helmet 1, such as the outer shell 2. The connectors 5 may also be connected to two or more parts of the remainder of the helmet 1

It should be understood that such an arrangement of the energy absorbing layer 3 and the interface layer 4 may be added to any helmet described herein.

FIG. 5 shows a helmet 1 comprising an outer layer 2 and an energy absorbing layer 3. Although not shown, an interface layer may additionally be provided.

The helmet 1 of FIG. 5 is configured such that the outer layer 2 is able to slide relative to the energy absorbing layer 3 in response to an impact. A sliding interface may be provided between the outer layer 2 and the energy absorbing layer 3

Although not shown, an additional layer may be provided on a surface of the energy absorbing layer 3 facing the sliding interface. The additional layer may be moulded to the energy absorbing layer 3 or otherwise attached thereto. The additional layer may be formed from a relatively hard material, e.g. relative to the energy absorbing layer 3. The additional layer may be configured to provide friction reducing means to reduce the friction at the sliding interface. This may be achieved by forming the additional layer from a low friction material, such as PC, PTFE, ABS, PVC, Nylon, PFA, FEP, PE and UHMWPE. Alternatively, or additionally, this may be achieved by applying a low friction coating to the additional layer and/or applying a lubricant to the additional layer.

Alternatively or additionally, friction reducing means, to reduce the friction at the sliding interface, may be provided by forming the outer layer 2 from a low friction material, providing an additional low friction layer on a surface of the outer layer 2 facing the sliding interface, by applying a low friction coating to the outer layer 2 and/or applying a lubricant to the outer layer 2.

The helmet 1 shown in FIG. 5 also comprises connectors 5 attached to the outer layer 2. The connectors 5 are also attached to the energy absorbing layer 3 (or additional layer) to allow relative sliding between the energy absorbing layer 3 and the sections of the interface layer 4. Alternatively or additionally, one or more of the connectors 5 may be connected to another part of the remainder of the helmet 1, such as an interface layer. The connectors 5 may also be connected to two or more parts of the remainder of the helmet 1.

It should be understood that such an arrangement of the outer shell 2 and the energy absorbing layer 3 may be added to any helmet described herein.

FIG. 6 shows a helmet 1 comprising an outer layer 2 and an energy absorbing layer 3. As illustrated, the energy absorbing layer 3 of the helmet shown in FIG. 6 is divided into outer and inner parts 3A, 3B. Although not shown, an interface layer may additionally be provided.

The helmet 1 of FIG. 6 is configured such that the outer part 3A of the energy absorbing layer 3 is able to slide relative to the inner part 3B of the energy absorbing layer 3 in response to an impact. A sliding interface may be provided between the outer part 3A of the energy absorbing layer 3 and the inner part 3B of the energy absorbing layer 3.

Although not shown, an additional layer may be provided on a surface of one or both of the inner and outer parts 3A, 3B of the energy absorbing layer 3 facing the sliding interface. The additional layer may be moulded to the inner or outer parts 3A, 3B of the energy absorbing layer 3 or otherwise attached thereto. The additional layer may be formed from a relatively hard material, e.g. relative to the energy absorbing layer 3. The additional layer may be configured to provide friction reducing means to reduce the friction at the sliding interface. This may be achieved by forming the additional layer from a low friction material, such as PC, PTFE, ABS, PVC, Nylon, PFA, FEP, PE and UHMWPE. Alternatively, or additionally, this may be achieved by applying a low friction coating to the additional layer and/or applying a lubricant to the additional layer.

Alternatively or additionally, friction reducing means, to reduce the friction at the sliding interface, may be provided by forming one or both of the inner and outer parts 3A, 3B of the energy absorbing layer 3 from a low friction material, providing an additional low friction layer on a surface of the inner and outer parts 3A, 3B of the energy absorbing layer 3 facing the sliding interface, by applying a low friction coating to the inner and outer parts 3A, 3B of the energy absorbing layer 3 and/or applying a lubricant to the inner and outer parts 3A, 3B of the energy absorbing layer 3.

The helmet 1 shown in FIG. 6 also comprises connectors 5 attached to the outer layer 2. The connectors 5 are also attached to the energy absorbing layer 3 (or additional layer) to allow relative sliding between the energy absorbing layer 3 and the sections of the interface layer 4. Alternatively or additionally, one or more of the connectors 5 may be connected to another part of the remainder of the helmet 1, such as an interface layer. The connectors 5 may also be connected to two or more parts of the remainder of the helmet 1.

It should be understood that such an arrangement of inner and outer parts 3A 3B of the energy absorbing layer 3 may be added to any helmet described herein.

FIG. 11 shows a helmet 1 substantially the same as the helmet shown in FIG. 6. However, in the helmet of FIG. 11, the inner part 3B of the energy absorbing layer 3 is formed in multiple parts 3C and 3D adjacent each other in the circumferential direction of the helmet. These parts 3C and 3D are configured to move relative to each other, as well as to the outer part 3A of the energy absorbing layer. The parts 3C and 3D may be connected to each other by one or more connectors that allow relative movement.

FIG. 7 shows a helmet 1 comprising an outer layer 2 and an energy absorbing layer 3. As shown in FIG. 7, one or more outer plates 7 are mounted to the outer layer 2 of the helmet 1. The outer plates 7 may be formed from a relatively strong and/or rigid material, for example from the same types of materials as from which the outer layer 2 may be formed. Although not shown, an interface layer may additionally be provided.

The helmet 1 of FIG. 7 is configured such that the outer plates 8 are able to slide relative to the outer layer 2 in response to an impact. A sliding interface may be provided between the outer plates 8 and the outer layer 2.

Friction reducing means, to reduce the friction at the sliding interface, may be provided by forming the outer layer 2 and/or the outer plates 8 from a low friction material, providing an additional low friction layer on a surface of the outer layer 2 and/or the outer plates 8 facing the sliding interface, by applying a low friction coating to the outer layer 2 and/or the outer plates 8, and/or applying a lubricant to the outer layer 2 and/or the outer plates 8.

The helmet 1 shown in FIG. 7 also comprises connectors 5 attached to the outer plates 7 The connectors 5 are also attached to the outer layer 2 to allow relative sliding between the plates 7 and the outer layer 2. Alternatively or additionally, one or more of the connectors 5 may be connected to another part of the remainder of the helmet 1, such as the energy absorbing layer 3. The connectors 5 may also be connected to two or more parts of the remainder of the helmet 1.

In such an arrangement, in the event of an impact on the helmet 1, it can be expected that the impact would be incident on one or a limited number of the outer plates 17. Therefore, by configuring the helmet such that the one or more outer plates 7 can move relative to the outer layer 2 and any outer plates 7 that have not been subject to an impact, the surface receiving the impact, namely one or a limited number of outer plates 7, can move relative to the remainder of the helmet 1. In the case of an impact, this may reduce the rotational acceleration of the head of a wearer.

It should be understood that such an arrangement of outer plates 7 may be added to any helmet described herein, namely an arrangement having a sliding interface between at least two of the layers of the helmet 1.

Some helmets, such as those shown in FIGS. 1 to 6, are configured to cover a top portion of the head and the above described helmet structures are appropriately located in the helmet to cover a top portion of the head. For example, a helmet may be provided to substantially cover the forehead, top of the head, back of the head and/or temples of the wearer. The helmet may substantially cover the cranium of the wearer.

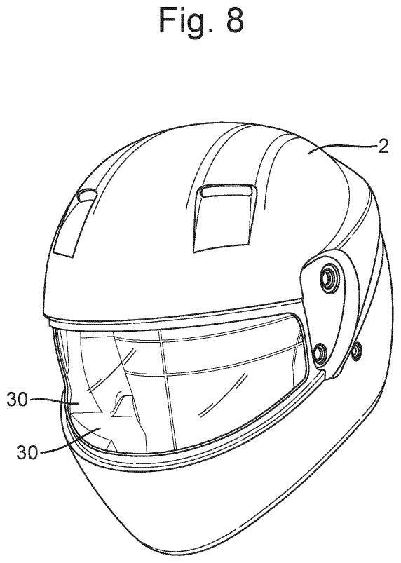

Some helmets may be configured to cover other parts of the head, alternatively or additionally to a top portion. For example, helmets such as the helmet shown in FIG. 8 may cover the cheeks and/or chin of the wearer. Such helmets may be configured to substantially cover the jaw of the wearer. Helmets of the type shown in FIG. 8, are often referred to as full-face helmets. As shown in FIG. 8, cheek pads 30 may be provided on either side of the helmet 1 (i.e. left and right sides). The cheek pads 30 may be arranged within an outer shell 2 of the helmet 1 to protect the side of the face of the wearer from an impact.

The cheek pads 30 may have the same layered structure as the example helmets described above. For example, the cheek pads 30 may comprise one or more energy absorbing layers as described above, and/or an interface layer as described above, and/or layers that move relative to each other as described above, optionally, layers may be connected by connectors as described above. Alternatively or additionally, the cheek pads 30 themselves may be configured to move relative to the outer shell 2 and, optionally be connected to the outer shell by connectors as described above.

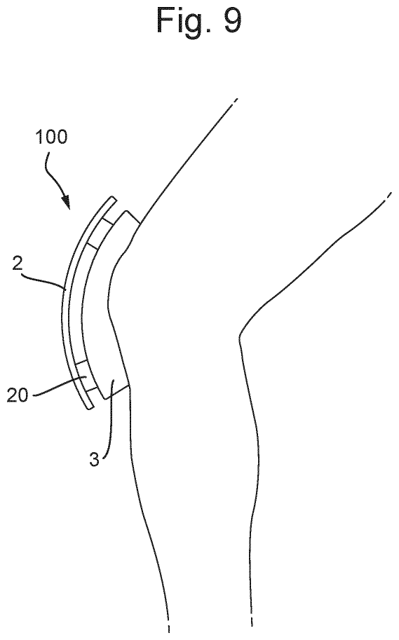

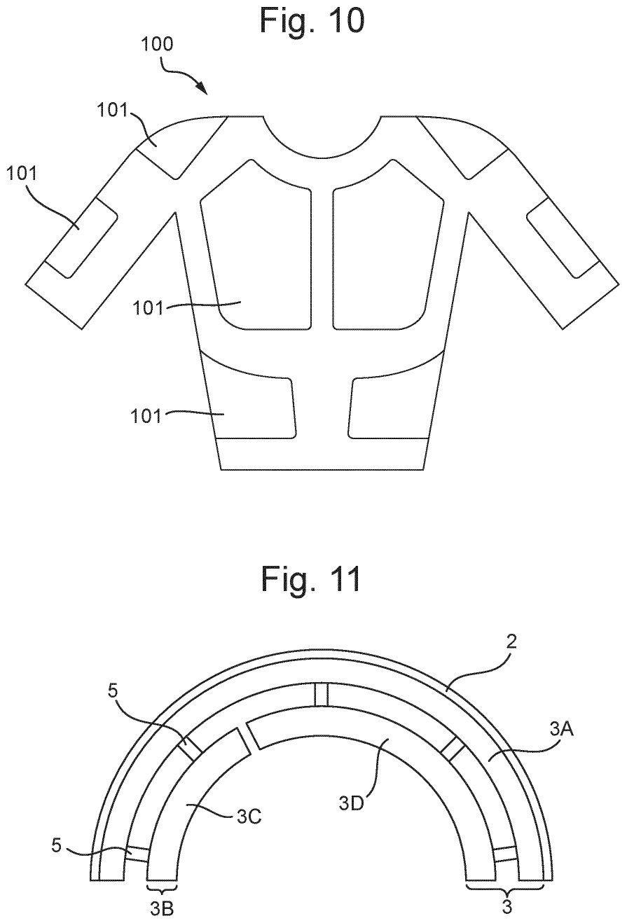

Although, the above examples relate to helmets, as stated above, the disclosure may also relate to alternative protective apparel, such as body armour, as shown in FIGS. 9 and 10. Body armour 100 may provide protection for other parts of the body, such as the shins, knees, thighs, forearms, elbows, upper arms, shoulders, chest and back. Individual items of body armour may be provided to protect individual body parts (as shown in FIG. 9), or alternatively may be combined in apparel comprising multiple armoured regions 101 to protect more than one body part (as shown in FIG. 10). Such body armour 100 may be worn for the same activities as helmets, discussed above, including for combat, sports, and motorcycling.

The body armour 100 may have the same layered structure as the example helmets described above. For example, the body armour 100 may comprise an outer shell 2 as described above, one or more energy absorbing layers 3 as described above, and/or an interface layer as described above, and/or layers that move relative to each other as described above, and/or layers may be connected by connectors 5 as described above.

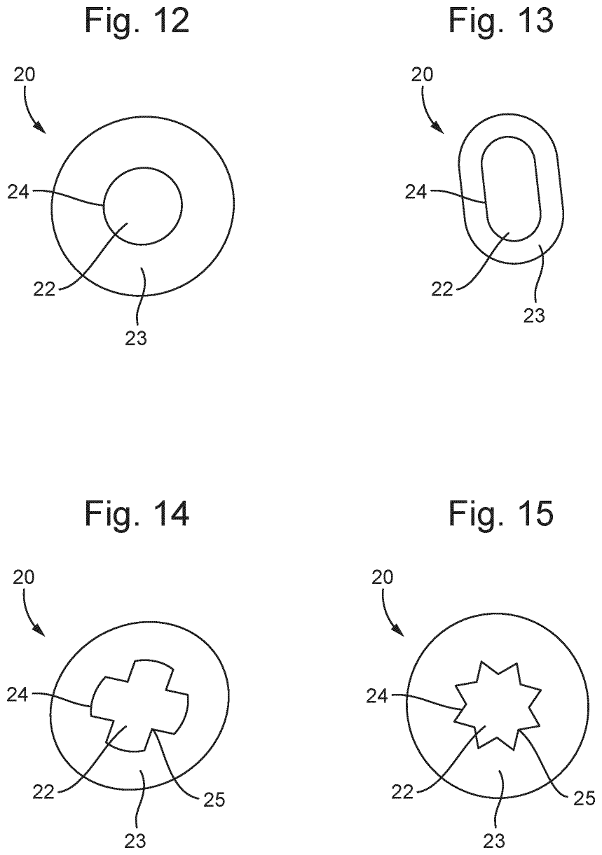

Connectors that may be used within a helmet, including any of the helmets described above, are described below, with reference to FIGS. 12 to 21. It should be appreciated that these connectors may be used in a variety of contexts and are not to be limited to use within helmets. For example, they may be used in other apparatuses, equipment or apparel that provide impact protection, such as body armour or padding for sports equipment.

It should be appreciated that the connectors may be used for connecting any two parts of an apparatus together. In the context of helmets, it should be appreciated in particular that the connectors may be used for connecting any two parts of helmets such as those discussed above that are configured to move relative to each other.

Where a connector is described as having a first part connected to a first part of an apparatus and a second part connected to a second part of an apparatus, it should be appreciated that, with suitable modifications, this may be reversed. It should also be appreciated that where an apparatus has first and second parts connected by plural connectors, the plural connectors need not have the same configuration as each other.

FIG. 12 shows a first example connector 20 according to the disclosure. FIG. 12 shows a first side of the connector 20, namely the top side. Although not visible in FIG. 12, the connector 20 comprises a first attachment part 21 configured to be attached to a first part 4 of a helmet 1. In one specific example, the first part 4 of the helmet 1 may be an interface layer, as described above. In this example connector 20, the first attachment part 21 is not visible in FIG. 12 because it may be arranged at the underside of the connector 20. As shown, in FIG. 12, the connector 20 comprises a second attachment part 22 configured to be attached to the second part 3 of the helmet 1. In one specific example, the second part 3 of the helmet 1 may be an energy absorbing layer, as described above. As shown, the second attachment part 22 may be arranged at the top side of the connector 20. As shown in FIG. 12, the connector 20 comprises a low friction layer 23. As shown, the low friction layer 23 may be arranged at the top side of the connector 20 also.

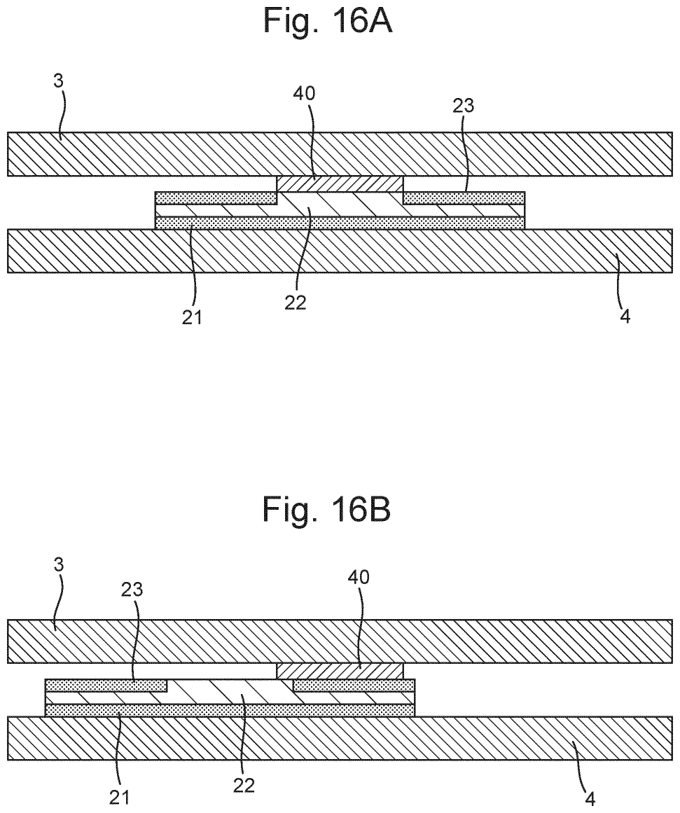

A shown in FIGS. 16A and 16B, the second attachment part 22 comprises a first part of a connecting means configured to be detachably attached to a second part of the connecting means 40 provided to the second part 3 of the helmet 1—in this example, an energy absorbing layer. The connection between the second attachment part 22 of the connector 20, and the energy absorbing layer 3 of the helmet 1 may be a detachable connection. For example, the connecting means may be specifically configured such that the connection can be attached and detached (and optionally re-attached, perhaps repeatedly) with no loss of function, i.e. without complete or partial destruction. In the example connector 20 shown in FIG. 12, the first part of the connecting means substantially forms the second attachment part 22. As such, for simplicity the numeral 22 will be used below with respect to the first part of the connecting means.

As shown in Figs, 12, 16A and 16B, the low friction layer 23 is arranged adjacent to the first part of the connecting means 22 in a lateral direction substantially perpendicular to a direction of connection between the first and second parts of the apparatus 4, 3. The direction of connection in the context of FIG. 12 is substantially into the page, i.e. substantially perpendicular to the side of the connector 20 that is visible in FIG. 12. The direction of connection in the context of FIG. 16 is substantially vertically on the page.

As shown in FIGS. 16A and 16A, the connector 20 is configured such that when the first part of the connecting means 22 is attached to the second part of the connecting means 40, the first part of the connecting means 22 is configured to detach from the second part of the connecting means 40 as the connector 20 is displaced in a lateral direction relative to the second part of the connecting means 40 such that the low friction layer 23 moves towards the second part of the connecting means 40. As shown, the low friction layer 23 is configured to slide against the second connecting means 40 as the first part of the connecting means 22 detaches therefrom.

FIG. 16A shows the arrangement of the connector 20 relative to the second part of the connecting means 40, before the above described movement is initiated. As shown, in this arrangement, the first part of the connecting means 22 and the second part of the connecting means 40 are fully attached to each other. FIG. 16B shows the arrangement of the connector 20 relative to the second part of the connecting means 40, after movement is initiated. As shown, in this arrangement, the first part of the connecting means 22 and the second part of the connecting means 40 are only partially attached to each other. As shown, the portion of the second part of the connecting means 40 that is not connected to the first part of the connecting means 22 slides against the low friction layer 23. Although, not shown, the first part of the connecting means 22 and the second part of the connecting means 40 may become completely detached if the relative movement is sufficient.

The connector 20 may therefore enable the first and second parts of the helmet 3, 4 to move relative to each other when the helmet 1 is subject to an impact.

Example connecting means include hook and loop connecting means, such as Velcro™, and magnetic connecting means. The example connector 20 shown in FIG. 12 comprises a hook and loop connecting means. One of the first part of the connecting means 22 and the second part of the connecting means 40 may be a hook part, and the other of the of the first part of the connecting means 22 and the second part of the connecting means 40 may be a loop part.

The relative movement permitted between the first and second parts of the helmet 4, 3 may be dependent on the force required to detach the first part of the connecting means 22 and the second part of the connecting means 40. This is dependent on the strength of the attachment. The attachment strength may be determined by the type connecting means and/or the size of the connecting surfaces. The relative movement between layers of the helmet 1 as a whole may also depend on the number of connectors 20 used and/or how these are arranged. Each of these features may be selected appropriately to provide the desired behaviour in the helmet 1.

As shown in FIG. 12, the low friction layer 23 may substantially surround the first part of the connecting means 22 in the lateral direction-the lateral direction being substantially in the plane of the page in the context of FIG. 12. As shown, the low friction layer 23 may form a closed loop surrounding the first part of the connecting means 22. As shown, the low friction layer 23 may comprise an aperture 24 surrounding the first part of the connecting means 22 in the lateral direction.

As shown in FIG. 12, the low friction layer 23 may be substantially annular in shape. As shown the connector 20 as a whole may be substantially circular in shape. As shown, the low friction layer 23 may cover substantially all of a surface of the connector 20 (except the aperture 24). Other example connectors may have a different shape to the example shown in FIG. 20. For example, a second example connector shown in FIG. 13 may have a substantially rounded-rectangular shape, e.g. a rectangle with rounded ends. The example connector 20 shown in FIG. 13 may otherwise be the same as the connector 20 shown in FIG. 12. Though not limited to any particular shape other examples of shapes that may be used include: rectangular, square, triangular, and oval.

The low friction layer 23 may be configured to facilitate detachment of the first part of the connecting means 22 from the second part of the connecting means 40. For example, as the second part of the connecting means 40 moves towards the low friction layer 23, contact with the low friction layer 23 may cause a contacting portion of the second part of the connecting means 40 to detach from the first part of the connecting means 22.

FIGS. 14 and 15 show third and fourth example connectors 20. These differ from the first example connector 20 shown in FIG. 12 in that at least a portion of an edge of the low friction layer 23 facing the first part of the connecting means 22 in the lateral direction comprises ridges, teeth or serrations. As shown, teeth 25 may point laterally inward towards a central region of the first part of the connecting means 22. The ridges, teeth or serrations may increase the surface area of the edge of the aperture 24 thus further facilitating detachment of the first part of the connecting means 22 from the second part of the connecting means 40. The ridges, teeth or serrations may be pointed. This may also further facilitate detachment of the first part of the connecting means 22 from the second part of the connecting means 40.

As shown in FIGS. 12 to 15, the low friction layer may be a thin material. For example, the low friction layer 23 may be no more than 2 mm thick, or no more than 1 mm thick. The low friction layer 23 may be substantially stiff. The low friction layer 23 may be formed from a plastic, for example. The low friction layer 23 may be formed from any one of PC, PTFE, ABS, PVC, Nylon, PFA, FEP, PE and UHMWPE, for example.

In some example connectors 20, such as those shown in FIGS. 12 to 15, the first attachment part 21 may comprise a first part of a second connecting means configured to be detachably attached to a second part of the second connecting means provided to the first part of the apparatus. Similarly to the first connecting means, example second connecting means include hook and loop connecting means, such as Velcro™, and magnetic connecting means. The example connectors 20 shown in FIGS. 12 to 15 comprise a hook and loop connecting means. One of the first part of the second connecting means and the second part of the second connecting means may be a hook part, and the other of the of the first part of the second connecting means and the second part of the second connecting means may be a loop part.

Although not the case for the example connectors shown in FIGS. 12 to 15, other example connectors may comprise a second low friction layer arranged adjacent to the first part of the second connecting means in a lateral direction substantially perpendicular to a direction of connection between the first and second parts of the apparatus 4, 3. The second low friction layer may have the same structural and functional features as described above with respect to the low friction layer 23.

In other example connectors, also not shown, the first attachment part may comprise an adhesive connection means. In yet further example connectors, the connection means may be provided by a material property of the first attachment part that is configured to bond to the first part of the helmet 4 by a bonding process, such as HF welding, heat or pressure bonding.

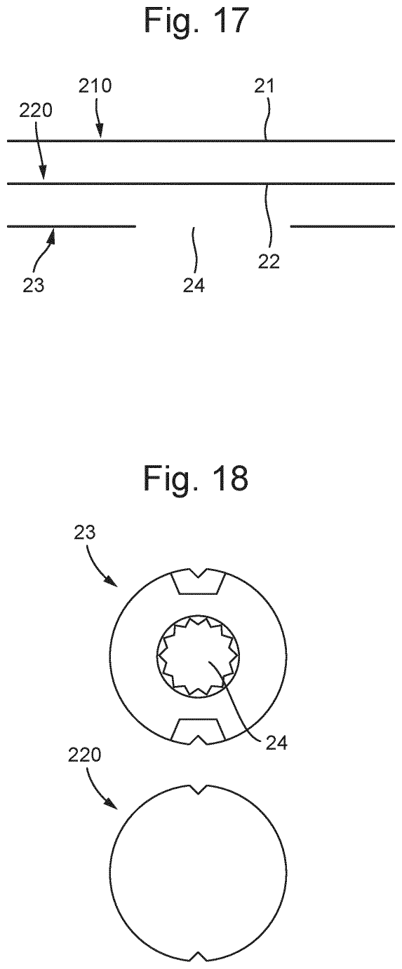

FIG. 17 shows example components forming an example connector 20 with a layered structure. As shown, the connector 20 may comprise a first layer 210 forming the first attachment part 21. As shown, the connector 20 may comprise a second layer 220, covering the first layer 210, forming the second attachment part 22. As shown, the low friction layer 23 may be a third layer, covering the second layer 220.

The example connectors 20 shown in FIGS. 12 to 15 have such a layered structure. For example, the entirety of the second layer 220 may be formed from a hook and loop material. The low friction layer 23 may be bonded to the portion of the second layer 220 that does not form the second attachment part 21 on a first side thereof. The entirety of the first layer 210 may be formed from a hook and loop material. The first layer 210 may be bonded to the second layer 220 on a second side thereof.

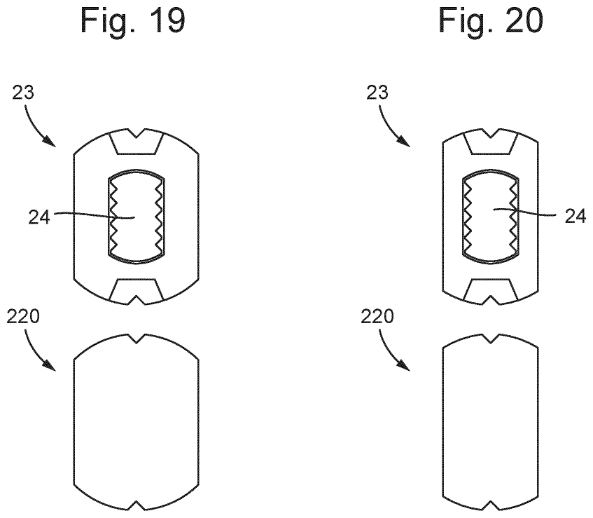

FIGS. 18 to 20 each show a low friction layer 23 and a second layer 220. These may be arranged on top of each other and bonded together. Each of the low friction layers 23 shown have toothed edges. As shown in FIG. 18, the teeth 25 may be arranged around the entirety of the perimeter of the aperture 24. Alternatively, as shown in FIGS. 19 and 20, teeth 25 may be provided only at portions of the perimeter of the aperture 24, e.g. along long edges of a substantially rectangular aperture 24.

One way in which the low friction layer 23 and the second layer 220 may be bonded together is by HF welding. If both the low friction layer 23 and the second layer 220 are made from suitable materials, such as plastic (e.g. PC and Nylon respectively) they may be HF welded at the outer region 20A shown in FIG. 21. The inner region 20B may be non-bonded. As shown, the inner region 20B may include the aperture 24. As shown, the inner region 20B may also include the ridges, teeth or serrations.

The first layer 210 may be bonded to the second layer 220 using an adhesive, for example.

As shown in FIGS. 12 to 15, the connector 20 may be substantially flat in the direction of connection between the first and second part of the apparatus 4, 3. As shown in FIG. 16, this may enable the gap between the first and second parts of the helmet 4, 3 to be reduced, or substantially eliminated. For example, the thickness of the connector 20 in the direction of connection between the first and second part of the apparatus 4, 3 may be less than 5 mm, or less than 3 mm.

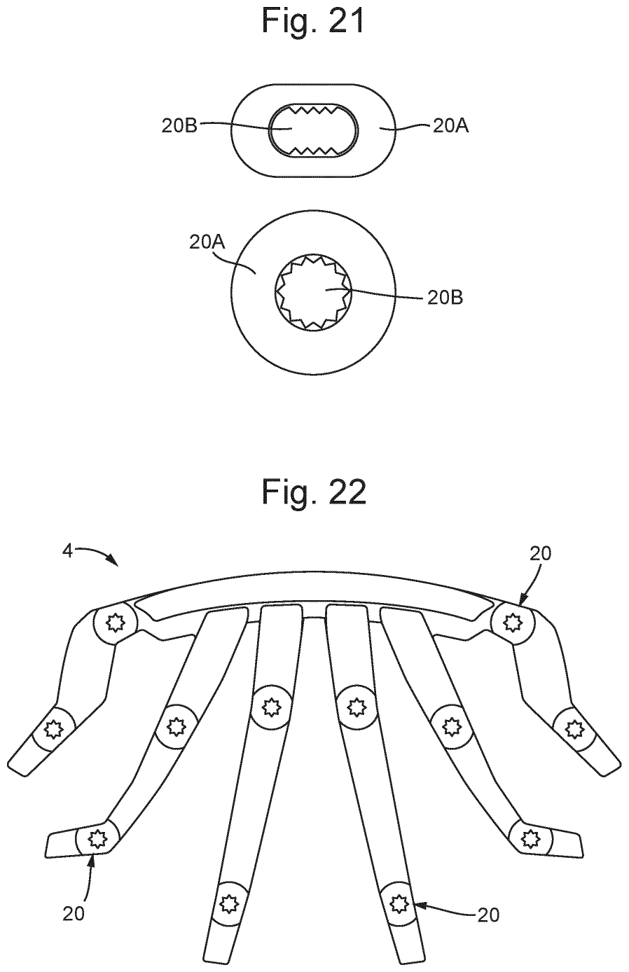

FIG. 22 shows an example interface layer 4 comprising a plurality of connectors 20 as described above. In this example, the connectors 20 may be HF welded to the interface layer, as described above.

As shown in FIG. 22 the connectors 20 may be substantially smaller in the lateral direction than the first and second parts of the apparatus 4, 3. For example, the connector 20 may have a maximum dimension in the lateral direction that does not exceed 50 mm. As shown, multiple connectors 20 may be used to connect the first and second parts of the apparatus 4, 3.

Helmets as described above may be used in various activities. These activities include combat and industrial purposes, such as protective helmets for soldiers and hard-hats or helmets used by builders, mine-workers, or operators of industrial machinery for example. Helmets, are also common in sporting activities. For example, protective helmets may be used in ice hockey, cycling, motorcycling, motor-car racing, skiing, snow-boarding, skating, skateboarding, equestrian activities, American football, baseball, rugby, soccer, cricket, lacrosse, climbing, golf, airsoft, roller derby and paintballing.

Examples of injuries that may be prevented or mitigated by the helmets described above include Mild Traumatic Brain Injuries (MTBI) such as concussion, and Severe Traumatic Brain Injuries (STBI) such as subdural haematomas (SDH), bleeding as a consequence of blood vessels rapturing, and diffuse axonal injuries (DAI), which can be summarized as nerve fibres being over stretched as a consequence of high shear deformations in the brain tissue.

Depending on the characteristics of the rotational component of an impact, such as the duration, amplitude and rate of increase, either concussion, SDH, DAI or a combination of these injuries can be suffered. Generally speaking, SDH occur in the case of accelerations of short duration and great amplitude, while DAI occur in the case of longer and more widespread acceleration loads.

Variations of the above described examples are possible in light of the above teachings. It is to be understood that the invention may be practiced otherwise and specifically described herein without departing from the spirit and scope of the invention.

1. A connector for connecting first and second parts of an apparatus, the connector comprising:
a first attachment part configured to be attached to the first part of the apparatus;
a second attachment part configured to be attached to the second part of the apparatus, the second attachment part comprising a first part of a connecting means configured to be detachably attached to a second part of the connecting means provided to the second part of the apparatus;
a low friction layer arranged adjacent to the first part of the connecting means in a lateral direction substantially perpendicular to a direction of connection between the first and second parts of the apparatus;
wherein, when the first part of the connecting means is attached to the second part of the connecting means, the first part of the connecting means is configured detach from the second part of the connecting means as the connector is displaced in a lateral direction relative to the second part of the connecting means such that the low friction layer moves towards the second part of the connecting means, and the low friction layer is configured to slide against the second connecting means as the first part of the connecting means detaches therefrom.

2. The connector of claim 1, wherein the connector is substantially smaller in the lateral direction than the first and second parts of the apparatus.

3. The connector of claim 1, wherein the low friction layer substantially surrounds the first part of the connecting means in the lateral direction, optionally wherein the low friction layer comprises an aperture surrounding the first part of the connecting means in the lateral direction, optionally wherein the low friction layer covers substantially all of a surface of the connector, except the aperture.

4. (canceled)

5. (canceled)

6. The connector of claim 1, wherein the low friction layer is configured to facilitate detachment of the first part of the connecting means from the second part of the connecting means.

7. The connector of claim 1, wherein at least a portion of an edge of the low friction layer facing the first part of the connecting means in the lateral direction is ridged, toothed or serrated.

8. The connector of claim 1, wherein the low friction layer is no more than 1 mm thick.

9. The connector of claim 1, wherein the low friction layer is substantially stiff.

10. The connector of claim 1, wherein the low friction layer is formed from plastic.

11. The connector of claim 1, wherein the connecting means is a hook and loop connecting means, wherein one of the first part of the connecting means and the second part of the connecting means is a hook part, and the other of the of the first part of the connecting means and the second part of the connecting means is a loop part.

12. The connector of claim 11, wherein the connector comprises a layer of hook or loop material, partially covered by the low friction layer such that a portion of the layer of hook or loop material is exposed, said exposed portion providing the second attachment part, optionally wherein the first attachment part is provided on the opposite side of the layer of hook or loop material to the low friction layer.

13. (canceled)

14. The connector of claim 1, wherein the first attachment part comprises a first part of a hook and loop connection means.

15. The connector of claim 1, wherein the first attachment part comprises an adhesive connection means.

16. The connector of claim 1, wherein the connector is substantially flat in the direction of connection between the first and second part of the apparatus.

17. The connector of claim 1, wherein the connector has a substantially circular, rectangular or rounded-rectangular shape.

18. The connector of claim 1, wherein the connector has a maximum dimension in the lateral direction that does not exceed 50 mm.

19. An apparatus comprising:
a first part;
a second part; and
at least one connector according to claim 1 connecting the first and second part of the apparatus;
at least one respective second part of the connecting means, attached to the second part of the apparatus.

20. The apparatus of claim 19, wherein the first and second parts of the apparatus are configured to move relative to each other in the lateral direction, the apparatus optionally comprising a low friction interface between the first and second parts of the apparatus.

21. (canceled)

22. The apparatus of claim 19, wherein at least one of the first part and the second part of the apparatus comprises a protective layer, optionally an energy absorbing layer or a hard shell, configured to protect against an impact to the apparatus, optionally wherein one of the first and second parts comprises an interface layer configured to interface with an object or person to be protected.

23. (canceled)

24. The apparatus of claim 19, wherein the apparatus is a helmet.

25. The apparatus of claim 19, wherein the apparatus is body armour.
